(19) United States
(12) Patent Application Publication
(10) Pub. No.: US 2017/0063643 A1
(43) Pub. Date: Mar. 2, 2017

(54) METHOD AND SERVER FOR GUARANTEEING SERVICE LEVEL OF PEER

(71) Applicant: Electronics and Telecommunications Research Institute, Daejeon (KR)

(72) Inventors: Chang Kyu LEE, Daejeon (KR); Wook HYUN, Daejeon (KR); Sung Hei KIM, Daejeon (KR); Ju Young PARK, Daejeon (KR)

(73) Assignee: Electronics and Telecommunications Research Institute, Daejeon (KR)

(21) Appl. No.: 15/246,765

(22) Filed: Aug. 25, 2016

(30) Foreign Application Priority Data
Aug. 28, 2015 (KR) 10-2015-0121996

(51) Int. Cl. H04L 12/24; H04L 29/08; H04L 12/26

(52) U.S. Cl. CPC H04L 41/5003; H04L 43/08; H04L 67/104; H04L 47/82

(57) ABSTRACT

Disclosed is a method of operating a server, the method including receiving peer status information from at least one peer, estimating a service reception quality of the peer by calculating a download speed of the peer based on the peer status information, identifying a target peer having the service reception quality less than or equal to a predetermined reference, and determining a helper peer to transmit data to the target peer based on the peer status information.

### CROSS-REFERENCE TO RELATED APPLICATION(S)

This application claims the priority benefit of Korean Patent Application No. 10-2015-0121996 filed on Aug. 28, 2015, in the Korean Intellectual Property Office, the disclosure of which is incorporated herein by reference for all purposes.

### BACKGROUND

1. Field

One or more example embodiments relate to a method and server for guaranteeing a service level of a peer or a quality of a service received by the peer.

2. Description of Related Art

A peer-to-peer (P2P) network may be a distributed network in which a peer is connected to other peers in lieu of a server, and contents can be exchanged among peer. In such network, the peer may function as a client receiving the contents and also function as a server providing the contents. Also, the P2P network may be formed based on contents to be shared in lieu of a predetermined server. For this reason, the number of connections among peers and a size of network may vary in the P2P network.

U.S. Patent Application Publication No. 2015-0142893 entitled “PEER-TO-PEER COMMUNICATION TO INCREASE DOWNLOAD THROUGHPUT” and published by Microsoft Corporation discloses a configuration in which a peer sends an aggressive peering request to another peer and, when the aggressive peering request is accepted, the other peer suspends uploading and mainly uploads data to the peer having transmitted the aggressive peering request.

### SUMMARY

An aspect provides technology for adjusting an overlay network to guarantee a service reception quality of a peer when the service reception quality is not guaranteed, for example, when a predetermined peer does not receive data from a plurality of peers even though the peer has a sufficient download bandwidth.

According to an aspect, there is provided a method of operating a server, the method including receiving peer status information from at least one peer, estimating a service reception quality of the peer by calculating a download speed of the peer based on the peer status information, identifying a target peer having the service reception quality less than or equal to a predetermined reference, and determining a helper peer to transmit data to the target peer based on the peer status information.

The estimating of the service reception quality may include calculating the download speed based on an amount of data downloaded by the peer over a predetermined period of time.

The identifying of the target peer may include comparing the download speed to at least one of a maximum download bandwidth and a target service quality of the peer, and identifying the target peer based on a comparison result.

The identifying of the target peer based on the comparison result may include verifying whether a difference between the download speed and at least one of the maximum download bandwidth and the target service quality of the peer is greater than or equal to a threshold, and identifying a peer having the difference greater than the threshold as the target peer.

The determining of the helper peer may include determining the helper peer using a connection availability and upload availability, wherein the connection availability is calculated based on maximum number of peer connection of the peer and a current number of peer connection of the peer, and wherein the upload availability is calculated based on maximum upload capacity of the peer and a current upload speed of the peer.

The determining of the helper peer may include calculating the upload speed of the peer based on an amount of data uploaded by the peer over a predetermined period of time.

The determining of the helper peer may include identifying a first peer having a download speed greater than or equal to a threshold speed, verifying upload speeds of second peers uploading data to the first peer, and determining, among the second peers, a third peer to be disconnected from the first peer based on the upload speed and determining the third peer to be the helper peer.

The method may further include determining a priority of the helper peer based on status information of the helper peer.

The determining of the priority may include determining a priority of a helper peer of which a participating state in an overlay network corresponds to a completed state to be a first priority and determining a priority of a helper peer that uploads a greatest amount of data to be a second priority when the participating state corresponds to a started state.

The determining of the priority may include determining the priority based on an upload bandwidth of the helper peer and an amount of data downloaded by the helper peer.

The method may further include controlling a cache server to participate in an overlay network when a number of helper peers is insufficient or when the helper peer is not determined, and allocating the cache server for the target peer.

The method may further include allocating the helper peer for the target peer.

According to another aspect, there is also provided a server including a communication interface configured to receive peer status information from at least one peer, a memory configured to store the peer status information, and a processor configured to perform a service quality guarantee procedure based on the peer status information, wherein the service quality guarantee procedure includes estimating a service reception quality of the peer by calculating a download speed of the peer based on the peer status information, identifying a target peer having the service reception quality less than or equal to a predetermined reference, and determining a helper peer to transmit data to the target peer based on the peer status information.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an example of adjusting an overlay network in which a peer participates according to an example embodiment;

FIG. 2 is a flowchart illustrating an operation method of a server according to an example embodiment;

FIG. 3 is a diagram illustrating an example of setting a target service quality according to an example embodiment;

FIG. 4 is a diagram illustrating an example of a peer registration and a report on status information according to an example embodiment; and

FIG. 5 is a block diagram illustrating a server according to an example embodiment.

### DETAILED DESCRIPTION

Hereinafter, some example embodiments will be described in detail with reference to the accompanying drawings.

Various alterations and modifications may be made to the examples. Here, the examples are not construed as limited to the disclosure and should be understood to include all changes, equivalents, and replacements within the idea and the technical scope of the disclosure.

The terminology used herein is for the purpose of describing particular examples only, and is not to be used to limit the disclosure. As used herein, the terms “a,” “an,” and “the” are intended to include the plural forms as well, unless the context clearly indicates otherwise.

As used herein, the terms “include, “comprise,” and “have” specify the presence of stated features, numbers, operations, elements, components, and/or combinations thereof, but do not preclude the presence or addition of one or more other features, numbers, operations, elements, components, and/or combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

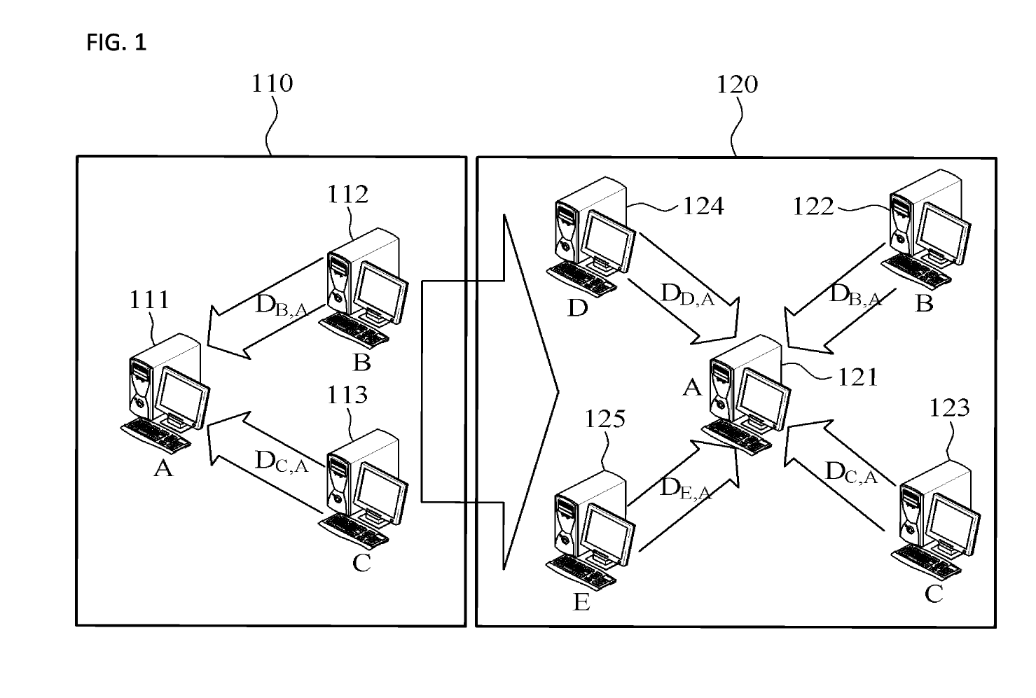

FIG. 1 is a diagram illustrating an example of adjusting an overlay network in which a peer participates according to an example embodiment.

Referring to FIG. 1, as indicated in a box 110, a plurality of peers, for example, a peer 111, a peer 112, and a peer 113 may be present. The peer 111 may receive data from the peer 112 and the peer 113. A current download speed D_{cur} of the peer 111 may be equal to, for example, D_{B,A}+D_{C,A}. Here, D_{N,M} denotes a rate of transmission from a peer N to a peer M. Although the peer 111 receives the data from the peer 112 and the peer 113, a service reception quality of the peer 111 may be relatively low. The low service reception quality may be provided when a download bandwidth of the peer 111 is relatively small. The low service reception quality may also be provided when a total upload speed of the peer 112 and the peer 113 is insufficient to guarantee a service quality although the download bandwidth of the peer 111 is sufficiently wide. An overlay network in which the peer 111 has been participating may be adjusted in response to an interconnection between a peer activity management server (PAMS) and an overlay management server (OMS). Based on an adjustment of the overlay network, the service reception quality of the peer 111 may be guaranteed. In this example, Dₘₐₓ may be a maximum download bandwidth of the peer 111, and D_{cur} may be the current download speed of the peer 111. The PAMS may calculate or estimate D_{cur} of the peer 111 based on status information reported from the peer 111. When a difference between Dₘₐₓ and D_{cur} is greater than or equal to a threshold, or when D_{cur} is smaller than a bit rate Dₛᵣᵥ that needs to be guaranteed to smoothly provide a service, the PAMS may prepare information used to increase D_{cur} and the OMS may use the information prepared by the PAMS. Through this, D_{cur} and the service reception quality of the peer 111 may increase.

In FIG. 1, as indicated by a box 120, a plurality of peers, for example, a peer 121, a peer 122, a peer 123, a peer 124, and a peer 125 may be present. In comparison to the example of the box 110, the peer 121 may also receive data from the peer 124 and the peer 125 in addition to the peer 122 and the peer 123. A current download speed D_{cur} of the peer 121 may be obtained by, for example, D_{E,A}+D_{D,A}+D_{C′,A}+D_{B,A}. Here, D_{C′,A} may be substituted by D_{C,A}. For example, in lieu of C′, C may transmit the data to the peer 121 and thus, D_{cur} may be equal to D_{E,A}+D_{D,A}+D_{C,A}+D_{B,A}. As discussed above, in response to the interconnection between the PAMS and the OMS, a number of peers transmitting data to the peer 121 may increase and thus, a service reception quality of the peer 121 may be guaranteed. Hereinafter, an example of guaranteeing a service reception quality of a peer will be described.

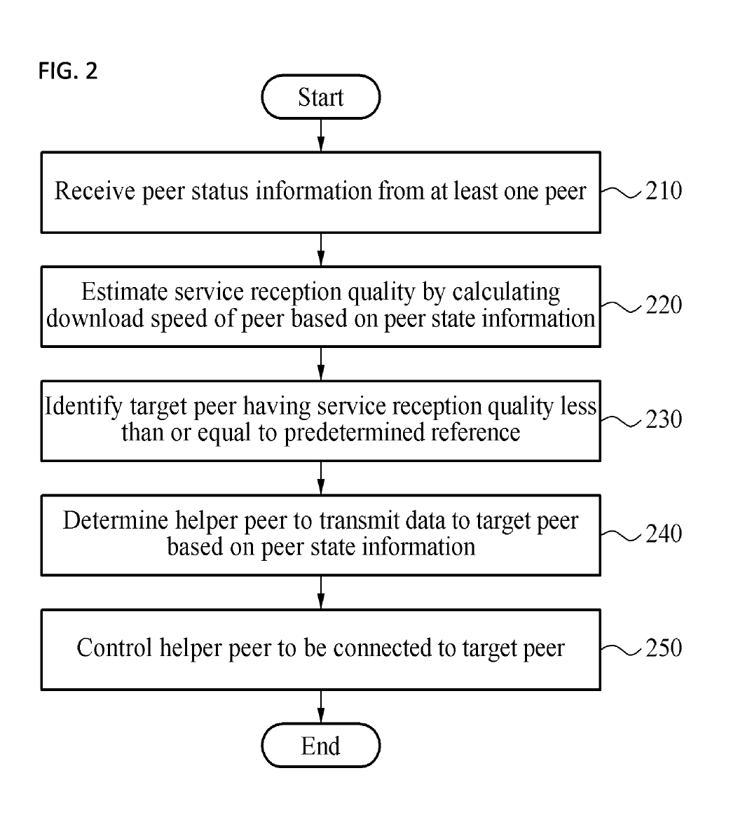

FIG. 2 is a flowchart illustrating an operation method of a server according to an example embodiment.

<Setting of Target Service Quality>

Although not shown in FIG. 2, a target service quality of a peer may be set. A user to initiate a session or a service may set a service reception quality of participants in a process of setting up the session or the service. For example, a service reception quality that needs to be guaranteed for smoothly providing a service or a minimum download bit rate required to receive the service in the peer may be set to be the target service quality. A service reception quality is set by a user initiating a session or a service when a peer registers meta-information or overlay network information on an index server (IXS) and/or an OMS, for example, the target service quality may be registered on the IXS and/or the OMS. Hereinafter, the user initiating the session or the service may also be referred to as an initiator. The IXS and the OMS will be described with reference to the following explanation.

The IXS may provide and manage meta-information of content used by the user for receiving a service. The IXS may manage meta-information of content and mapping information between the content and an overlay network. Also, the IXS may provide meta-information for the user and a peer with the information on an OMS which the peer needs to access in order to receive a service.

The OMS may generate and manage information about a P2P network configured to provide content. Also, the OMS may provide and/or manage information on a P2P network to peers such that the peers join the P2P network.

The IXS and/or the OMS may register and/or set a target service quality based on information received from an initiator or a peer.

<Collecting Peer Status Information>

In operation 210, the PAMS may receive peer status information from at least one peer. The peer status information may include, for example, static information and dynamic information of the peer. The peer may send a registration request to the PAMS, and the PAMS may register the peer. The PAMS may send a response with a message indicating that the peer is registered. In addition to the registration confirmation, the response message may also include a report period. When the peer is registered on the PAMS, the peer may report the static information to the PAMS. The peer may report the static information every time that a profile is changed. Here, the profile may indicate information set for the peer to operate as a peer in the P2P network. The profile may change in response to a change in a P2P network policy or a P2P network status. Also, based on the report period received from the PAMS, the peer may report the dynamic information to the PAMS at an interval of the report period.

The static information of the peer may be shown in Table 1, and the dynamic information of the peer may be shown in Table 2.

TABLE 1

| Type | Element | Meaning |
|---|---|---|
| Static | Maximum download BW | Maximum global download |
| information | | bandwidth of peer |
| Static | Maximum download BW | Maximum download |
| information | per overlay network | bandwidth per overlay |
| | | network of peer |
| Static | Maximum upload BW | Maximum global upload |
| information | | bandwidth of peer |
| Static | Maximum upload BW per | Maximum upload |
| information | overlay network | bandwidth per overlay |
| | | network of peer |
| Static | Maximum number of | Maximum number of |
| information | connections for upload | connections for upload |
| | per overlay network | per overlay network of |
| | | peer |

TABLE 2

| Type | Element | Meaning |
|---|---|---|
| Dynamic | OVERLAY_ID | ID of overlay network in which |
| information | | peer participates |
| Dynamic | OverlayEvent | Overlay network participation state |
| information | | |
| Dynamic | Downloaded | Total amount of data downloaded by |
| information | | peer participating in overlay network |
| | | after peer starts operation (in unit |
| | | of kilobytes (KB)) |
| Dynamic | Uploaded | Total amount of data uploaded by |
| information | | peer participating in overlay network |
| | | after peer starts operation (in unit |
| | | of KB) |
| Dynamic | Left | Amount of data to be additionally |
| information | | downloaded to complete download |
| | | (in unit of KB) |
| Dynamic | Connec- | Number of connections currently |
| information | tions_for_up | maintained for upload |
| Dynamic | Connec- | Number of connections currently |
| information | tions_for_dn | maintained for download |
| Dynamic | Piece-event | Transmission and reception result |
| information | | of unit piece |

OverlayEvent of the dynamic information may indicate a participation state of a peer in an overlay network or an operation state of the peer in the overlay network. For example, OverlayEvent may include a started state of the peer or a completed state of the peer. Here, the completed state may be a state in which receiving of contents is completed in the peer, and the started state may be a state in which the peer is receiving the contents.

Piece-event of the dynamic information may indicate a result of transmitting and receiving a piece in the peer. Piece-event may also indicate information on the piece transmitted or received by the peer. For example, Piece-event may be classified into transmission information and reception information. The transmission information may include identification information of a piece transmitted by the peer, identification information of a counterpart peer, for example, identification information of another peer receiving the piece transmitted from the peer, and type information indicating that the piece is to be transmitted. The reception information may include identification information of a piece received by the peer, identification information of a counterpart peer, for example, identification information of another peer transmitting the piece received by the peer, information on an integrity of the piece, and type information indicating that the piece is to be received. When the peer reports Piece-event to the PAMS, the PAMS may verify a piece or a plurality of pieces retained by the peer. For example, the PAMS may use Piece-event to verify the piece or the pieces retained by the peer.

<Identifying a Target Peer>

In operation 220, the PAMS may estimate a service reception quality by calculating a download speed of the peer based on the state information.

The PAMS may estimate the service reception quality of the peer every time that the dynamic information is reported by the peer according to Equation 1 as below.

$${D}_{CUR} = \frac{{DIFF}_{DOWNLOADED}}{PERIOD} \qquad [ Equation 1 ]$$

In Equation 1, DIFF_{DOWNLOADED} denotes a difference between a downloaded value reported at a point in time t and a downloaded value reported at a point in time t-1 before the point in time t. DIFF_{DOWNLOADED} may be expressed as shown in Equation 2. Also, in Equation 1, PERIOD denotes a report period of the dynamic information.

DIFF_{DOWNLOADED}=DOWNLOADEDₜ−DOWNLOADEDₜ₋₁ [Equation 2]

The PAMS may calculate a current download speed, for example, D_{CUR} of the peer based on an amount of data downloaded by the peer during the report period and estimate D_{CUR} as the service reception quality of the peer.

In operation 230, when the service reception quality of the peer is estimated, the PAMS may identify a target peer having a service reception quality less than or equal to a predetermined reference.

The PAMS may compare D_{CUR} to D_{SRV} set by the initiator or D_{MAX} reported by the peer as the dynamic information. In this example, D_{MAX} may be a maximum download bandwidth (BW) per overlay network of the peer. When the PAMS does not receive a report on the maximum download BW per overlay network of the peer, D_{MAX} may be a maximum global download BW. When the PAMS does not receive a report on the maximum download BW per overlay network of the peer, the PAMS may set the maximum global download BW to be D_{MAX}.

When D_{SRV} is set, the PAMS may compare D_{CUR} to D_{SRV}. When D_{SRV} is not set, the PAMS may compare D_{CUR} to D_{MAX}. Specifically, when D_{SRV} is set, the PAMS may calculate a first difference between D_{SRV} and D_{CUR} and verify whether the first difference is greater than a first threshold. The first threshold may be, for example, zero. The PAMS may identify a peer having the first difference greater than the first threshold to be the target peer.

When D_{SRV} is not set, the PAMS may calculate a second difference between D_{MAX} and D_{CUR} and verify whether the second difference is greater than a second threshold. The PAMS may identify a peer having the second difference greater than the second threshold to be the target peer. The identifying of the target peer in the PAMS may be represented by an algorithm as below.

On receiving dynamicReport
{

calculate DIFF_{DOWNLOADED};
calculate D_{CUR};
if(isSet(D_{SRV}))

D_{DIFF} = D_{SRV} − D_{CUR}
if(D_{DIFF} > 0)

doAction(peer_id)

else

D_{DIFF} = D_{MAX} − D_{CUR}
if(D_{DIFF} > THRESHOLD)

doAction(peer_id)

}

When D_{SRV} is set, the predetermined reference in operation 230 may be D_{SRV}. When D_{SRV} is not set, the predetermined reference in operation 230 may be D_{MAX}-THRESHOLD. A peer having D_{CUR} less than D_{SRV} or a peer having D_{CUR} less than D_{MAX}-THRESHOLD may be determined to be the target peer.

According to the algorithm, the PAMS may verify whether the peer having the service reception quality less than the predetermined reference, for example the target peer is present.

<Determining of Helper Peer>

In operation 240, the PAMS may determine a helper peer to transmit data to the target peer based on the state information.

The PAMS may verify whether an additional upload connection of the peer is available. The PAMS may use a maximum number of connections for upload, for example, MAX_{CON}_{_}_{UP} of the peer or a maximum number of connections for upload per overlay network, for example, MAX_{CON}_{_}_{UP}^{NET} of the peer to verify whether the additional upload connection of the peer is available. The PAMS may calculate a first availability, for example, AVAIL_{CON} according to Equation 3 and verify whether the additional upload connection of the peer is available based on the first availability.

AVAIL_{CON}=[MAX_{CON}_{_}_{UP}^{NET}|MAX_{CON}_{_}_{UP}]−CON_{UP} [Equation 3]

When MAX_{CON}_{_}_{UP}^{NET} is reported to the PAMS, the PAMS may calculate AVAIL_{CON} of the peer based on MAX_{CON}_{_}_{UP}^{NET} and CON_{UP}. When MAX_{CON}_{_}_{UP}^{NET} is not reported to the PAMS, the PAMS may calculate AVAIL_{CON} of the peer based on MAX_{CON}_{_}_{UP} and CON_{UP}. Here, CON_{UP} denotes Connections_for_up reported as the dynamic information and indicates the number of connections maintained for an upload.

When the additional upload connection of the peer is available, the PAMS may verify whether the peer is capable of performing an upload. The PAMS may calculate a current upload speed or an upload bit rate, for example, U_{CUR} based on a report period and an uploaded value reported as the dynamic information. The current upload speed of the peer may be expressed by Equation 4 as below.

$${U}_{CUR} = \frac{{DIFF}_{UPLOADED}}{PERIOD} \qquad [ Equation 4 ]$$

In Equation 4, DIFF_{UPLOADED} denotes a difference between an uploaded value reported at the point in time t and an uploaded value reported at the point in time t-1, and may be expressed by Equation 5 as below.

DIFF_{UPLOADED}=UPLOADEDₜ−UPLOADEDₜ₋₁ [Equation 5]

The PAMS may verify whether the peer is capable of performing the upload using the current upload speed of the peer and a maximum upload BW per overlay network, for example, MAX_{CAP}_{_}_{UP}^{NET} of the peer. Also, when the PAMS does not receive a report on MAX_{CAP}_{_}_{UP}^{NET}, the PAMS may use the current upload speed of the peer and a maximum upload BW, for example, MAX_{CAP}_{_}_{UP} of the peer to verify whether the peer is capable of performing the upload. For example, the PAMS may compare MAX_{CAP}_{_}_{UP}^{NET} or MAX_{CAP}_{_}_{UP} to the current upload speed of the peer to verify whether the peer is capable of performing the upload. Also, the PAMS may calculate a second availability, for example, AVAIL_{CAPA} of the peer according to Equation 6 and verify whether the peer is capable of performing the upload based on the second availability.

AVAIL_{CAPA}=[MAX_{CAP}_{_}_{UP}^{NET}|MAX_{CAP}_{_}_{UP}]−U_{CUR} [Equation 6]

The PAMS may calculate the second availability by calculating a difference between MAX_{CAP}_{_}_{UP}^{NET} and U_{CUR} or a difference between MAX_{CAP}_{_}_{UP} and U_{CUR}. When the second availability is greater than equal to a threshold level, the PAMS may determine that the peer is capable of performing the upload. When the second availability is less than the threshold level, the PAMS may determine that the peer is incapable of performing the upload. The PAMS may determine a peer having the second availability greater than or equal to the threshold level to be the helper peer. The determining of the helper peer in the PAMS may be represented by an algorithm as below.

for each peer except the target
{

calculate AVAIL_{CON};
calculate AVAIL_{CAPA};
if((AVAIL_{CON} > 0) &&

(AVAIL_{CAPA} > THRESHOLD))
checkAsHelper(peer_id)

}

The PAMS may calculate the first availability and the second availability of the peer excluding the target peer. A peer having the first availability greater than zero and the second availability greater than the threshold level may be determined to be the helper peer. Alternatively, the PAMS may calculate the first availability of the peer excluding from the target peer, calculate the second availability of a peer having the first availability greater than zero, and determine a peer having the second availability greater than the threshold level to be the helper peer.

As discussed above, the PAMS may verify the first availability, and then verify the second availability based on a verification of the first availability. Also, the PAMS may verify the second availability, and then verify the first availability based on a verification of the second availability. For example, the PAMS may verify whether the peer is capable of performing an additional upload. When the peer is capable of performing the additional upload, the PAMS may verify whether an additional upload connection of the peer is available.

When a predetermined period of time elapses after a peer reports the dynamic information, the peer may be excluded from a process of determining the helper peer.

When the helper peer is absent, or when a number of helper peers is insufficient, the PAMS may allocate a peer transmitting data for another peer receiving a service with at least a normal level of quality to be the helper peer. For example, a peer B may receive a service from a peer A having no spare resources. Even though the peer B does not receive the service from the peer A, a problem may not occur in a service reception quality of the peer B. In this example, the PAMS may allow the peer A to provide the service to the target peer, that is, a peer corresponding to a service reception quality lower than that of the peer B. A normal level of service reception quality may be denoted by, for example, D_{SRV}. When D_{SRV} is not set, the normal level of service reception quality may be D_{MAX} of the peer A. When D_{CUR} of a predetermined peer is greater than D_{SRV} or D_{MAX}, the PAMS may forcedly allocate, for the target peer, a portion of a plurality of peers transmitting data to the predetermined peer. The PAMS may verify upload speeds of a plurality of peers transmitting data to the peer having D_{CUR} greater than D_{SRV} or D_{MAX} based on Piece-event of the dynamic information. The PAMS may verify the upload speeds of the plurality of peers transmitting the data to the peer having D_{CUR} greater than D_{SRV} or D_{MAX} according to Equation 7 as below.

$${U}_{CUR} = \frac{nPiece \times Piece size}{PERIOD} \qquad [ Equation 7 ]$$

In Equation 7, n-Piece denotes a number of pieces and Piece size denotes a size of piece.

The PAMS may verify at least one peer not to transmit the data to the peer having D_{CUR} greater than D_{SRV} or D_{MAX}. In this example, the peer having D_{CUR} greater than D_{SRV} or D_{MAX} may be the peer receiving the service with at least the normal level of quality. The PAMS may determine the verified at least one peer to be the helper peer.

<Helper Peer Allocation>

In operation 250, an OMS may control the helper peer to be connected to the target peer. The OMS may allocate the helper peer for the target peer. Specifically, as discussed above, the PAMS may identify the target peer, determine the helper peer, and control the helper peer to be connected to the target peer. The OMS may control the helper peer to be connected to the target peer in conjunction with the PAMS.

When the helper peer is determined, the PAMS and/or the OMS may determine a priority of the helper peer. For example, when the helper peer is determined, the PAMS and/or the OMS may determine the helper peer to provide a relatively favorable connection to the target peer. For each case of a file sharing application and a multimedia streaming application, the priority of the helper peer may be set differently.

(1) File Sharing Application

In the file sharing application, the PAMS and/or the OMS may select peers of which OverlayEvent corresponds to a started state or a completed state from peers participating in the same overlay network. In this example, peers in the completed state may have all data or all pieces for file sharing and thus, may acquire a highest priority. Among peers in the started state, a peer having a relatively large Uploaded may acquire a subsequently high priority. The foregoing example may be based on, for example, a case in which the peer having the relatively large Uploaded has a large amount of data or data that is popular in a piece scheduling algorithm and frequently requested from other peers.

(2) Multimedia Streaming

In the multimedia streaming where content transmission is to satisfy a predetermined bit rate, the peer may need to receive data at a predetermined multimedia bit rate or higher in order to receive a normal service. To guarantee a service reception quality, a download bit rate of the peer may need to be greater than or equal to a target bit rate. Thus, the PAMS and/or the OMS may allocate the helper peer such that a download bit rate of the target peer satisfies the target bit rate.

The download bit rate of the target peer may increase when a peer having a sufficient upload bandwidth and a relatively large amount of effective data is selected as the helper peer. Through this, the PAMS and/or the OMS may allocate, for the target peer, a helper peer having a relatively large Downloaded among helper peers having spare resources.

(3) Use of Cache Server

In the file sharing application and the multimedia streaming application, when the number of helper peers is insufficient or the helper peer is absent, the OMS may initiate a cache server (CS) into the overlay network and allocate the cache server for the target peer.

(4) Helper Peer Allocation Method

A helper peer allocation method may vary based on a type of P2P network. In a PULL-type of P2P network, the OMS may provide information on the helper peer to the target peer as a peer list. In a PUSH-type of P2P network, the OMS may control the helper peer to transmit data to the target peer. Also, when the cache server is used, the cache server may be allocated to be the helper peer.

In an example embodiment, the PAMS may forcedly cancel a connection to a peer having a relatively low upload speed among upload speeds calculated according to Equation 7, and connect the peer to the target peer. When the OMS has a function to control a configuration of the P2P network and peers operate under a control of the OMS, it is possible to forcedly cancel a connection to a peer and allocate the peer for another peer. As discussed above, among peers transmitting data to a peer having D_{CUR} greater than D_{SRV} or D_{MAX}, at least one peer to operate as the helper peer may be determined by the PAMS. Hereinafter, for example, the peer having D_{CUR} greater than D_{SRV} or D_{MAX} may also be referred to as a first peer, the peers transmitting the data may be referred to as second peers, and the peer to operate as the helper peer may also be referred to as a third peer. The PAMS may verify the first peer, identify the third peer from among the second peers uploading data to the first peer, and determine the third peer to be the helper peer. In this example, a peer list excluding the third peer may be generated, and the generated peer list may be provided to the first peer. The first peer may receive the peer list excluding the third peer, and cancel a connection to the third peer or establish a connection to a peer other than the third peer so as to be disconnected from the third peer. Through this, the first peer may be disconnected from the third peer. The peer list excluding the third peer may be generated in conjunction between the OMS and the PAMS.

In an example embodiment, to increase D_{CUR} of the target peer, the OMS may allow the helper peer or the cache server to transmit data to the target peer. Also, the target peer may send a connection request to the helper peer or the cache server to transmit the data to the target peer. Through this, the number of peers to be allocated to the target peer may increase and thus, D_{CUR} of the target peer may also increase, which may lead to an increase in the service reception quality of the target peer.

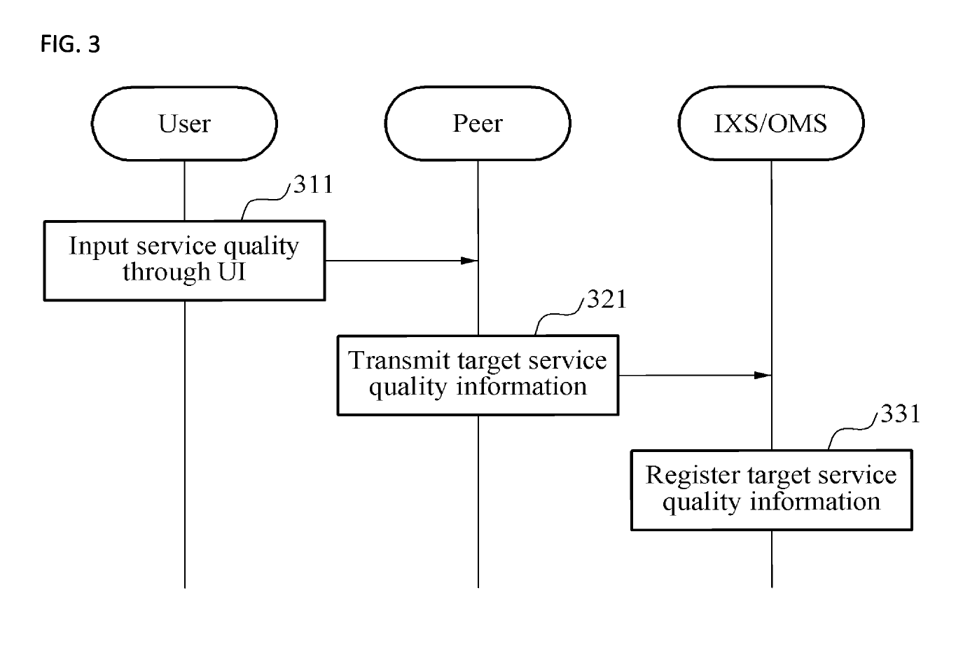

FIG. 3 is a diagram illustrating an example of setting a target service quality according to an example embodiment.

A user, for example, an initiator may set a target service quality of participant of a service or a session established by the initiator. In this example, the participants may be, for example, peers other than a peer. For example, the initiator may input a service quality through a user interface (UI) in operation 311, and a minimum download speed for another peer may be set to be a target service quality. The initiator may upload meta-information to an IXS and the peer may transmit the target service quality information set by the initiator to an OMS in operation 321. When transmitting overlay network information to the OMS, the peer may transmit the target service quality information to the OMS. The IXS and/or the OMS may register the target service quality information when registering the meta-information or the overlay network information in operation 331.

When a user does not set the target service quality information, the PAMS may operate based on a maximum download bandwidth of the peer and a download bandwidth reported to the PAMS to guarantee a service reception quality of the peer.

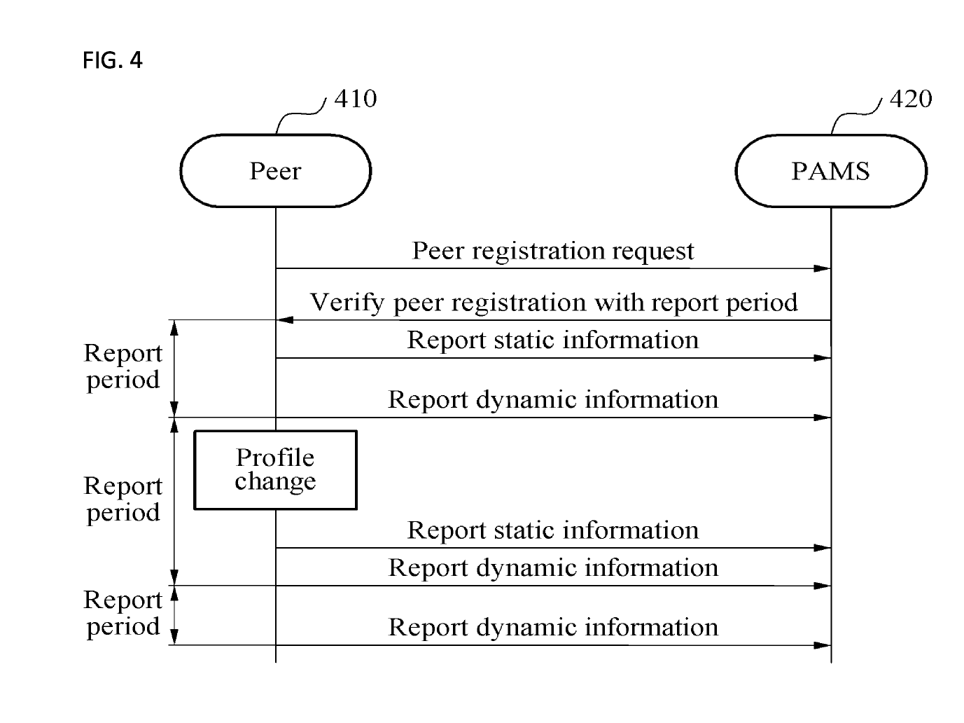

FIG. 4 is a diagram illustrating an example of a peer registration and a report on status information according to an example embodiment.

Referring to FIG. 4, a peer 410 may request a PAMS 420 to perform a peer registration. In response to a registration request from the peer 410, the PAMS 420 may register the peer 410 on the PAMS 420. The peer 410 may receive a message indicating that the peer 410 is registered from the PAMS 420. Also, the PAMS 420 may transmit a report period to the peer 410.

The report period may start from a point in time at which the message is received. The peer 410 may report static information to the PAMS 420. The peer 410 may report the static information to the PAMS 420 as represented by Table 1 above. When a profile of the peer 410 remains the same, the peer 410 may not report the static information to the PAMS 420.

The peer 410 may report the static information of Table 2 to the PAMS 420 at intervals of the report period.

In an example of FIG. 4, the peer 410 may change in a second report period. As discussed above, the profile of the peer 410 may change in response to a change in a P2P network policy or a P2P network status. The peer 410 may inform the PAMS 420 of the change in the profile of the peer 410 through a report on the static information.

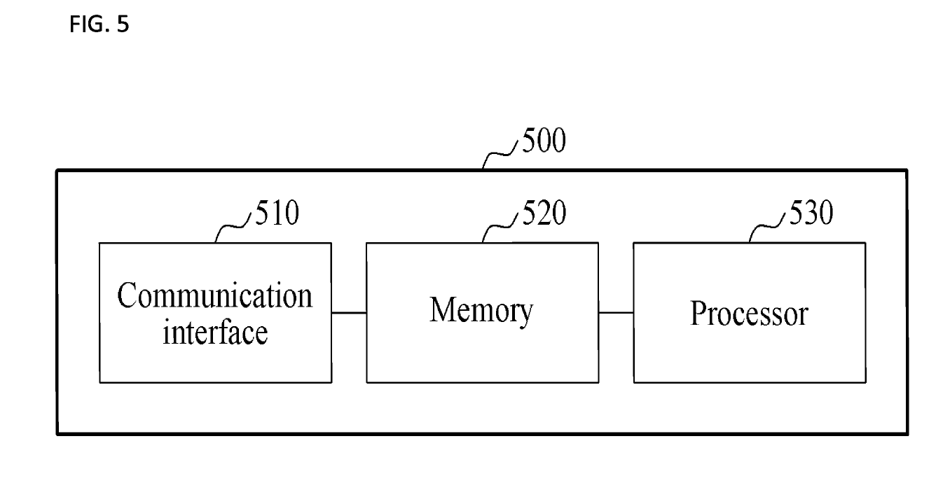

FIG. 5 is a block diagram illustrating a server according to an example embodiment.

Referring to FIG. 5, a server 500 may include a communication interface 510, a memory 520, and a processor 530.

The communication interface 510 may receive peer status information from at least one peer. The peer status information may include, for example, static information and dynamic information.

The memory 520 may store the peer status information.

The processor 530 may perform a service quality guarantee procedure based on the peer status information. Here, the service quality guarantee procedure may include the following operations.

(1) An operation of estimating a service reception quality of a peer by calculating a download speed of the peer based on the peer status information

(2) An operation of identifying a target peer having a service reception quality less than or equal to a predetermined reference

(3) An operation of determining a helper peer to transmit data to the target peer based on the peer status information

The processor 530 may calculate a current download speed of the peer based on an amount of data downloaded by the peer over a predetermined period of time. The predetermined period of time may be, for example, a report period.

The processor 530 may compare the current download speed to a maximum download capacity of the peer. The maximum download capacity may include, for example, a maximum download bandwidth of the peer. Also, the processor 530 may compare the current download speed to a target service quality of the peer. The processor 530 may identify the target peer based on at least one of a comparison result between the maximum download capacity and the current download speed and a comparison result between the target service quality and the current download speed. For example, when the target service quality is set, the processor 530 may verify whether a first difference between the current download speed and the target service quality is greater than or equal to a first threshold and may identify a peer having the first difference greater than or equal to the first threshold to be the target peer. When the target service quality is not set, the processor 530 may verify whether a second difference between the maximum download bandwidth and the current download speed is greater than or equal to a second threshold and may identify a peer having the second difference greater than or equal to the second threshold to be the target peer.

When the target peer is identified, to determine a helper peer among peers other than the target peer, the processor 530 may verify whether an additional upload connection of the peer is available based on the peer status information and calculate an upload speed of the peer based on an amount of data uploaded by the peer over a predetermined period of time. As discussed above, the processor 530 may calculate a first availability to verify whether the additional upload connection is available. For example, when the first availability is greater than zero, the processor 530 may verify that the additional upload connection is available. When the additional upload connection is available, the processor 530 may determine the helper peer based on a comparison result between the upload speed and a maximum upload bandwidth of the peer. For example, the processor 530 may verify whether a third difference between the maximum upload bandwidth and the upload speed is greater than a third threshold and determine a peer having the third difference greater than or equal to the third threshold to be the helper peer. As discussed above, the processor 530 may calculate a second availability. Here, the second availability may correspond to, for example, the third difference.

When the number of helper peers is insufficient or the helper peer is not determined through a process of determining the helper peer, the processor 530 may identify a first peer having a download speed greater than or equal to a threshold speed among the peers other than the target peer. The processor 530 may verify upload speeds of second peers uploading data to the first peer. As discussed above, the processor 530 may verify the upload speeds of the second peers according to Equation 7. Based on the upload speeds of the second peers, the processor 530 may determine a third peer from among the second peers and determine the third peer to be the helper peer. In this example, the third peer may be a peer having a relatively low upload speed among the upload speeds of the second peers, and a connection between the third peer and the first peer may be forcedly cancelled.

When the helper peer is determined, the processor 530 may allocate the helper peer for the target peer. Also, when the helper peer is determined, the processor 530 may determine a priority of the helper peer based on status information of the helper peer before allocating the helper peer to the target peer. The processor 530 may determine the helper peer to provide a relatively favorable connection to the target peer. For each case of a file sharing application and a multimedia streaming application, the priority of the helper peer may be set differently.

In the file sharing application, the priority of the helper peer may be determined based on at least one of an amount of data uploaded by the helper peer and a participation state of the helper peer in an overlay network. For example, a highest priority may be given to a helper peer in the participation state in the overlay network corresponding to a completed state. Also, when the participation state in the overlay network corresponds to a started state, a subsequently high priority may be given to a helper peer having a greatest amount of uploaded data.

In the multimedia streaming application, a relatively high priority may be given to a helper peer having a relatively high value, for example, Downloaded as shown in Table 2, among helper peers having spare resources. For example, the priority of the helper peer may be determined based on an upload bandwidth of the helper peer and an amount of data downloaded by the helper peer

A helper peer allocation method may vary based on a type of P2P network. In a PULL-type of P2P network, the processor 530 may provide information on the helper peer to the target peer as a peer list. In a PUSH-type of P2P network, the processor 530 may control the helper peer to transmit data to the target peer. Also, when a cache server is used, the cache server may be allocated to be the helper peer.

When the number of helper peers is insufficient or the helper peer is not determined, the processor 530 may control the cache server to participate in the overlay network. The processor 530 may allocate the cache server for the target peer.

Since the descriptions of FIGS. 1 through 4 are also applicable to an example of FIG. 5, repeated descriptions will be omitted for brevity.

In an example embodiment, a peer can experience low service quality even though it has enough resources to get better quality of service. In such case, the peer activity information stored in PAMS can be utilized to increase service quality. When peer suffers from low performance, and PAMS is aware of this situation through analysis of the received dynamic status information reports. Procedures for re-organizing overlay network to enhance service quality are performed, as follows.

(1) Peer periodically reports its activity status information.

(2) Peer can periodically request OMS for latest peer list. Upon receiving the request, OMS requests PAMS for optimized peer list regarding the requesting peer. PAMS detects that the requesting peer is suffering from low service quality. For example, PAMS can compare download speed of the corresponding peer with the maximum download bandwidth. Download speed can be calculated by using amount of downloaded data and report period. PAMS tries to find an appropriate peer(s) which can assist in improving service quality. For example, PAMS can use both connection availability and upload availability; connection availability can be calculated through maximum number of peer connection and the current number of peer connection, and upload availability can be calculated through maximum upload capacity and current upload speed. PAMS responds with the peer list containing the helper peer(s). The connection availability, for example, corresponds to the first availability and the upload availability, for example, corresponds to the second availability. The maximum number of peer connection, for example, corresponds to the “Maximum number of connections for upload per overlay network” of Table 1, and the maximum upload capacity corresponds to the “Maximum upload BW” or “Maximum upload BW per overlay network” of Table 1.

(3) OMS responds to peer with the peer list containing helper peer(s). Peer will connect to the helper peers in the received peer list. Eventually, service quality of the peer will be improved by the received fragment(s) from helper peer(s).

In a push-based overlay network, OMS can control helper peer(s) to send fragment(s) to the target peer.

According to example embodiments, it is possible to provide technology for adjusting an overlay network to guarantee a service reception quality of a peer when the service reception quality is not guaranteed, for example, when a predetermined peer does not receive data from a plurality of peers even though the peer has a sufficient download bandwidth.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of operating a server, the method comprising:
receiving peer status information from at least one peer;
estimating a service reception quality of the peer by calculating a download speed of the peer based on the peer status information;
identifying a target peer having the service reception quality less than or equal to a predetermined reference; and
determining a helper peer to transmit data to the target peer based on the peer status information.

2. The method of claim 1, wherein the estimating of the service reception quality includes calculating the download speed based on an amount of data downloaded by the peer over a predetermined period of time.

3. The method of claim 1, wherein the identifying of the target peer includes:
comparing the download speed to at least one of a maximum download bandwidth and a target service quality of the peer; and
identifying the target peer based on a comparison result.

4. The method of claim 3, wherein the identifying of the target peer based on the comparison result includes:
verifying whether a difference between the download speed and at least one of the maximum download bandwidth and the target service quality of the peer is greater than or equal to a threshold; and
identifying a peer having the difference greater than the threshold as the target peer.

5. The method of claim 1, wherein the determining of the helper peer includes:
determining the helper peer using a connection availability and upload availability,
wherein the connection availability is calculated based on maximum number of peer connection of the peer and a current number of peer connection of the peer, and
wherein the upload availability is calculated based on maximum upload capacity of the peer and a current upload speed of the peer.

6. The method of claim 5, wherein the determining of the helper peer includes:
calculating the upload speed of the peer based on an amount of data uploaded by the peer over a predetermined period of time.

7. The method of claim 1, wherein the determining of the helper peer includes:
identifying a first peer having a download speed greater than or equal to a threshold speed;
verifying upload speeds of second peers uploading data to the first peer; and
determining, among the second peers, a third peer to be disconnected from the first peer based on the upload speed and determining the third peer to be the helper peer.

8. The method of claim 1, further comprising:
determining a priority of the helper peer based on status information of the helper peer.

9. The method of claim 8, wherein the determining of the priority includes determining a priority of a helper peer of which a participating state in an overlay network corresponds to a completed state to be a first priority and determining a priority of a helper peer that uploads a greatest amount of data to be a second priority when the participating state corresponds to a started state.

10. The method of claim 8, wherein the determining of the priority includes determining the priority based on an upload bandwidth of the helper peer and an amount of data downloaded by the helper peer.

11. The method of claim 1, further comprising:
controlling a cache server to participate in an overlay network when a number of helper peers is insufficient or when the helper peer is not determined; and
allocating the cache server for the target peer.

12. The method of claim 1, further comprising:
allocating the helper peer for the target peer.

13. A server comprising:
a communication interface configured to receive peer status information from at least one peer;
a memory configured to store the peer status information; and
a processor configured to perform a service quality guarantee procedure based on the peer status information,
wherein the service quality guarantee procedure includes:
estimating a service reception quality of the peer by calculating a download speed of the peer based on the peer status information;
identifying a target peer having the service reception quality less than or equal to a predetermined reference; and
determining a helper peer to transmit data to the target peer based on the peer status information.
